(19) United States
(12) Patent Application Publication
(10) Pub. No.: US 2007/0096437 A1
(43) Pub. Date: May 3, 2007

(54) Trolley

(76) Inventor: Mark Andrew Watson, Eaglemont (AU)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/265,920

(22) Filed: Nov. 3, 2005

(51) Int. Cl. B62B 3/02

(52) U.S. Cl. 280/651

(57) ABSTRACT

A trolley or cart (10) for supporting and transporting a plurality of bags or containers (12). The trolley (10) including a frame having a base section (52,54,66,68,70,72) and at least one stanchion (32) coupled to the base section (52,54,66,68,70,72). The at least one stanchion (32) including at least two telescoping sections (32′,32″) coupled together in a slidable relationship. A height adjustment means (34) is associated with the at least one stanchion (32) which enables the length of the at least one stanchion (32) to be selectively adjusted by raising and lowering an upper telescoping section (32′) relative to a lower telescoping section (32″). Wheel means (94,96,108,110) are rotatably coupled to the base section (52,54,66,68,70,72) of the frame and at least one handle member (106) is coupled to the upper telescoping section (32″) of the at least one stanchion (32) for selectively manipulating the trolley (10). The trolley (10) further including at least one support member (28) coupled to and extending substantially laterally from the at least one stanchion (32) at or near the upper telescoping section (32′) of the at least one stanchion (32) in a load supporting position. The at least one support member (28) being adapted to receive and support the plurality of bags or containers (12).

### FIELD OF THE INVENTION

The present invention relates, generally, to wheeled trolleys or carts and relates particularly, though not exclusively, to a trolley for supporting and transporting a plurality of bags or containers. More particularly, the present invention relates to a shopping trolley for supporting and transporting a plurality of detachable shopping bags or containers and which includes a collapsible frame for loading into a motor vehicle.

It will be convenient to hereinafter describe the invention in relation to a shopping trolley, however it should be appreciated that the trolley of the present invention is not limited to that use only.

### BACKGROUND OF THE INVENTION

Any discussion of documents, devices, acts or knowledge in this specification is included to explain the context of the invention. It should not be taken as an admission that any of the material forms a part of the prior art base or the common general knowledge in the relevant art in Australia or elsewhere on or before the priority date of the disclosure and claims herein.

In the past, it has been the conventional practice of most consumers to carry or transport groceries from place to place in plastic shopping bags provided by a grocery store. Often these plastic bags are manually loaded into store shopping trolleys by the consumer and transported from the point of sale to the consumers motor vehicle where they are then removed from the trolley and placed by hand into the vehicle to be transported home. Upon arriving at home, the shopping bags are unloaded from the vehicle and carried inside by hand by the consumer.

Many problems and difficulties have been encountered by consumers when employing such a conventional practice. For example, in the case of elderly consumers, or consumers having limited upper body strength, the use of a store shopping trolley whilst within the grounds of a retail precinct is considered invaluable as without the store trolley their shopping bags would need to be carried by hand from the point of sale to their vehicle which they may not be able to do. However, upon arriving at home, unless the consumer has their own trolley available for use, or has a capable person whom can assist them at home, the shopping bags must be lifted out of their vehicle and lugged inside by hand. The action of placing shopping bags into a store shopping trolley, removing the bags from the trolley and placing them in a vehicle, and then removing the bags from the vehicle and lugging them inside can be a labour intensive exercise and an exercise of which some people are physically not capable of doing.

Aside from the problems that such a conventional practice presents to consumers, the use of plastic bags themselves is now considered a major source of environmental pollution.

To overcome the problems and difficulties of using such a conventional practice, so-called personal shopping trolleys have been developed, however, it is considered that none are very convenient.

U.S. Pat. No. 5,678,842, which issued to Hook et al. on 21 Oct., 1997, discloses a collapsible shopping trolley for transporting a plurality of handled shopping bags and which can be folded to a compact size for storage and transportation. This trolley is designed for personal use by a consumer and allows them to support and transport shopping bags from the point of sale to their vehicle, and then from their vehicle to inside their home. By using this trolley a consumer no longer needs to use a store shopping trolley whilst within a shopping precinct, and more importantly upon arriving at their home a consumer has a means of transporting their shopping bags from their vehicle to inside their home. However the use of this trolley still requires a consumer to unhook and lift the shopping bags from the trolley and into their vehicle and again from their vehicle and onto the trolley for transportation into their house. Also, as this trolley is primarily designed to carry handled shopping bags which can be looped over a series of lugs or hooks disposed on a support arm, it is considered that use of this trolley will encourage the use of conventional singlet-type disposable plastic bags which as already discussed are a major source of environmental pollution.

It is therefore an object of the present invention is to provide an improved trolley or cart for supporting and transporting a plurality of bags or containers which overcomes some or all of the problems previously discussed.

### SUMMARY OF THE INVENTION

According to the present invention there is provided a trolley, preferably a shopping trolley, including: a frame having a base section and at least one stanchion coupled to said base section, said at least one stanchion including at least two telescoping sections coupled together in a slidable relationship; a height adjustment means enabling the length of said at least one stanchion to be selectively adjusted by raising and lowering an upper telescoping section of said at least two telescoping sections relative to a lower telescoping section of said at least two telescoping sections; wheel means rotatably coupled to said base section of said frame; at least one handle member coupled to said upper telescoping section of said at least one stanchion for selectively manipulating said trolley; and at least one support member coupled to said at least one stanchion at or near said upper telescoping section of said at least one stanchion, wherein said at least one support member extends substantially laterally from said at least one stanchion in a load supporting position and said at least one support member is adapted to receive and support at least one load carrying bag or container.

Preferably said at least one support member of said trolley includes at least two telescoping sections coupled together in a slidable relationship which enable the length of said at least one support member to be selectively adjusted in order to vary the load carrying capacity thereof. It is also preferred that said trolley is adapted to receive and support a plurality of load carrying bags or containers, and wherein said at least two telescoping sections of said at least one support member enable the length of said at least one support member to be selectively adjusted in order to receive and support more or less bags or containers as required.

In a practical preferred embodiment said at least one support member of said trolley includes three telescoping sections coupled together in a slidable relationship. It is preferred that each of said three telescoping sections of said at least one support member of said trolley are adapted to receive and support a single bag or container. It is also preferred that said trolley includes two support members and said two support members can be selectively adjusted to enable said trolley to receive and support up to six bags or containers.

In a further practical preferred embodiment said at least one support member and said base section are disposed in a parallel relationship. In this practical embodiment it is preferred that the length of said base section of said frame is selectively adjustable in order to counteract the load received and supported on said at least one support member of said trolley.

In yet a further practical preferred embodiment said trolley includes one stanchion having two telescoping sections, one telescoping section being the upper telescoping section and the other telescoping section being the lower telescoping section, and wherein one of said upper and lower telescoping sections slidably receives therein the other of said upper and lower telescoping sections. In one aspect said height adjustment means of said stanchion may include a threaded rod disposed internally of or adjacent to said upper and lower telescoping sections, wherein said threaded rod is rotatably fixed at or near one end thereof to one of said upper or lower telescoping sections, and wherein said threaded rod is threadably received within a captively held nut fixedly connected to the other or said upper and lower telescoping sections. In this embodiment it is preferred that said trolley includes a height adjustment control lever disposed above said stanchion which is coupled to and rotates with said threaded rod, said control lever being selectively operable in a clockwise or anti-clockwise direction to impart a rotational movement on said threaded rod, and wherein said rotational movement of said threaded rod causes said threaded rod to move up or down relative to said captively held nut which in turn selectively adjusts the height of said stanchion.

In a further aspect said height adjustment means of said stanchion may include a threaded rod disposed internally of or adjacent to said upper and lower telescoping sections, wherein said threaded rod is rotatably fixed at or near one end thereof to one of said upper or lower telescoping sections, and wherein said threaded rod is threadably received within a captively held nut disposed at or near one end of a cylindrical tube disposed substantially within or adjacent to the other or said upper and lower telescoping sections, and wherein said cylindrical tube includes a pinion gear disposed at or near the end of said cylindrical tube. In this embodiment said trolley preferably further includes a motor having a shaft with a worm gear formed thereon, said worm gear being disposed adjacent said pinion gear of said cylindrical tube, said trolley including control means to selectively control said motor in order to impart a clockwise or anti-clockwise rotational movement on said shaft of said motor, wherein when said shaft of said motor is rotated, said worm gear imparts a rotational movement on said cylindrical tube by way of said pinion gear, and wherein said rotational movement of said cylindrical tube causes said threaded rod to move up or down relative to said captively held nut which in turn selectively adjusts the height of said stanchion.

In yet a further aspect, said height adjustment means of said stanchion is a hydraulic or pneumatic lifting mechanism disposed internally of or adjacent to said upper and lower telescoping sections.

It is preferred that said trolley can be folded to collapsed position for storage and/or transportation purposes.

In yet a further practical preferred embodiment said wheel means of said trolley includes two rear wheels rotatably coupled to said base section of said frame at or near a rear end thereof, and two forward swivel or castor wheels rotatably coupled to said base section of said frame at or near a forward end thereof. Preferably a braking means is coupled to at least one of said rear wheels, wherein said braking means is controllable via at least one brake lever disposed on or near said at least one handle member of said trolley or is controllable via pivotal movement of said at least one handle member of said trolley.

### ADVANTAGES OF THE INVENTION

Accordingly, the present invention provides an improved trolley or cart, preferably a shopping trolley, which can be used to support and transport a plurality of detachable bags or containers, and which can be raised or lowered for ease of loading and unloading of the plurality of detachable bags.

The trolley of the present invention is also preferably selectively adjustable to accommodate more or less bags or containers as required depending on the intended use of the trolley. The trolley of the present invention therefore enables one trolley to be used for multiple applications.

Finally, as the trolley of the present invention preferably uses purposely designed reusable bags or containers, it is considered that use of the trolley of the invention will substantially reduce the effects that conventional plastic singlet-type bags have on the environment.

### BRIEF DESCRIPTION OF THE DRAWINGS

In order that the invention may be more clearly understood and put into practical effect there shall now be described in detail preferred constructions of a trolley or cart in accordance with the invention. The ensuing description is given by way of non-limitative example only and is with reference to the accompanying drawings, wherein:

FIGS. 1a to 1c are front perspective views of a trolley made in accordance with a first preferred embodiment of the present invention;

FIG. 2a is a front perspective view of the trolley of FIGS. 1a to 1c, showing the detachable bags removed from the trolley;

FIG. 2b is a similar view to that of FIG. 2a, this time showing the trolley after being adjusted to accommodate fewer detachable bags;

FIG. 3 is a rear elevation view of the trolley of FIGS. 1a to 1c;

FIG. 4 is a similar view to that of FIG. 2a, showing the stanchion of the trolley in an extended or raised position;

FIG. 5 is an enlarged partial cross-sectional view of the lifting mechanism of the stanchion of the trolley of FIGS. 1a to 1c;

FIG. 6 is an enlarged partial cross-sectional view of the upper section of the stanchion of the trolley of FIGS. 1a to 1c;

FIG. 7 is an enlarged partial cross-sectional view of the inner side of one of the rear wheels of the trolley of FIGS. 1a to 1c;

FIG. 8a is a front perspective view of the trolley of FIGS. 1a to 1c, showing the trolley in a collapsed position;

FIG. 8b is a rear perspective view of the trolley of FIGS. 1a to 1c, showing the trolley in a collapsed position;

FIG. 8c is a side elevation view of the trolley of FIGS. 1a to 1c, showing the trolley in a collapsed position;

FIGS. 9a to 9d are side elevation views of the trolley of FIGS. 1a to 1c, showing the trolley, in use, in varying stages of operation during the loading of the detachable bags into the luggage compartment of a motor vehicle;

FIG. 10a is a rear perspective view of a trolley made in accordance with a second preferred embodiment of the present invention; and

FIGS. 10b & 10c are enlarged partial cross-sectional views of the lifting mechanism of the stanchion of the trolley of FIG. 10a.

### DETAILED DESCRIPTION OF THE PREFERRED EMBODIMENTS

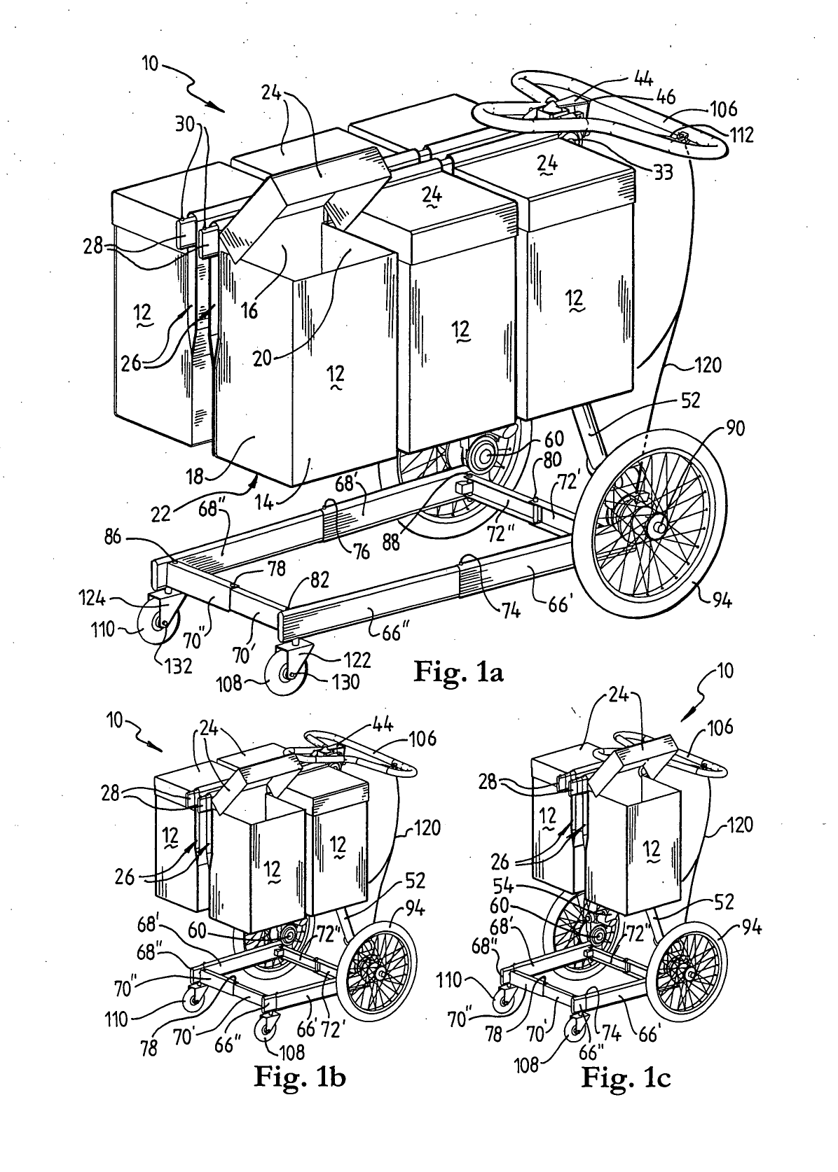

In FIGS. 1a to 1c there is shown a trolley or cart 10, suitable for use as a shopping trolley, designed to carry a plurality of detachable shopping bags or baskets 12. It should be understood however, that trolley 10 may be used for many other applications and as such the invention is not limited to the specific example as shown.

As can be best seen in FIGS. 1a & 3, detachable bags 12 each have a generally rigid box-like design with front and rear sides 14,16, left and right sides 18,20, a base 22 and a lid 24. Disposed on rear side 16 of each of bags 12 is a sleeve 26 for slidably receiving therein a substantially horizontal bag support member 28 of trolley 10. Sleeves 26 facilitate the attachment and removal of bags 12 relative to trolley 10. It should be understood that bags 12 may take many other forms to that shown in the accompanying representations and as such the invention is not limited to the specific example provided. Hence, throughout the ensuing description any reference to bag or bags 12 is intended to refer to any suitable bag or container which can be removably attached to trolley 10 for carrying groceries or other items.

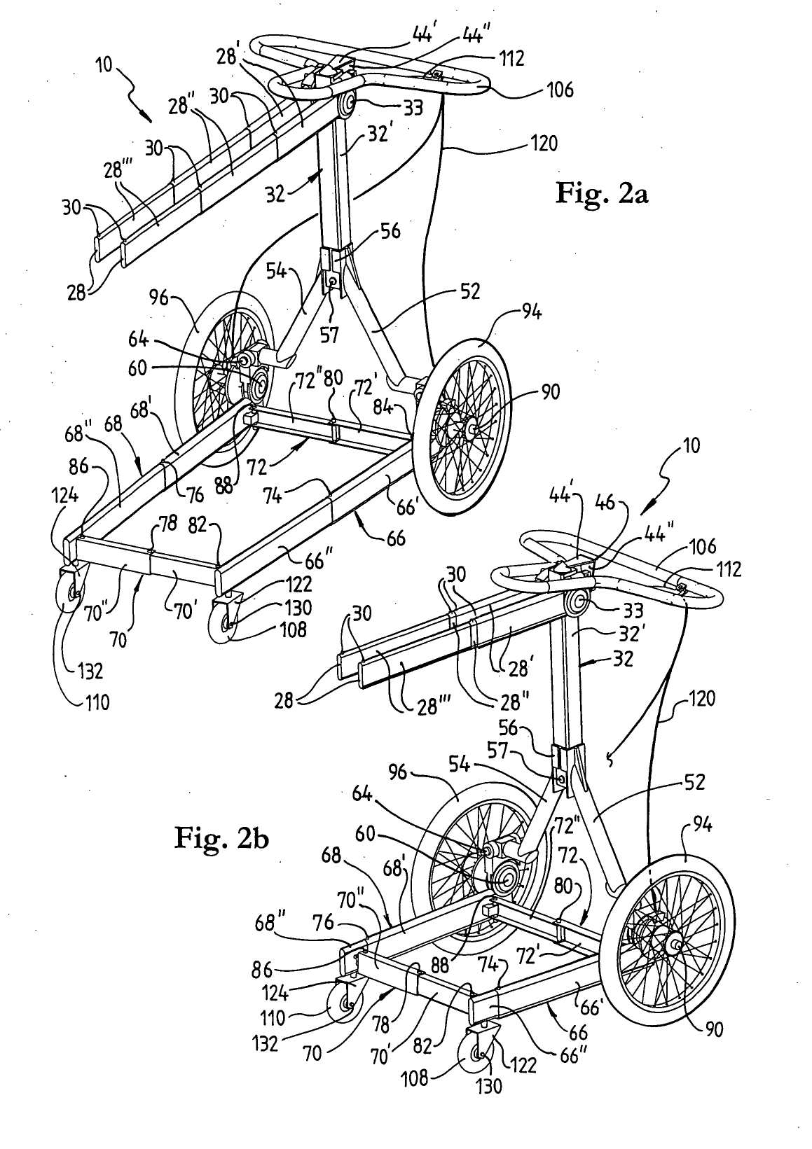

Referring particularly to FIGS. 1a to 2b, it can be seen that trolley 10 includes a pair of spaced apart parallel bag support members 28, each of which are designed to slidably receive and carry a plurality of bags 12. Each bag support member 28 is composed of a first, second and third section 28′,28″,28′″ (see FIG. 2a) which are disposed in a telescoping arrangement in order that first section 28′ is adapted to slidably receive therein second section 28″, and second section 28′ is adapted to slidably receive therein third section 28′″. The telescoping arrangement of bag support members 28 enables trolley 10 to be selectively and manually adjusted to accommodate more or less bags 12 as required.

In accordance with the preferred embodiment shown in FIGS. 1a to 9d, each of sections 28′,28″,28′″ of bag support members 28 are designed to accommodate a single bag 12, meaning trolley 10 can be selectively adjusted to support and transport two (FIG. 1c), four (FIG. 1b) or six bags (FIG. 1a), respectively. It should be understood however, that bag support members 28 of trolley 10 may take many other forms. Similarly, each section 28′,28″,28′″ of bag support member(s) 28 may accommodate more or less than one bag 12 depending on the required application of trolley 10 and as such the invention is not limited to the specific example as shown.

To enable bag support members 28 to be locked into the two, four or six bag configurations shown in FIGS. 1a to 1c, bag support members 28 are each provided with a series of spring loaded locking pins 30. Locking pins 30 enable telescoping first, second and third sections 28′,28″,28′″ of bag support members 28 to be selectively and releasably locked into any of a number of desired extended or retracted positions.

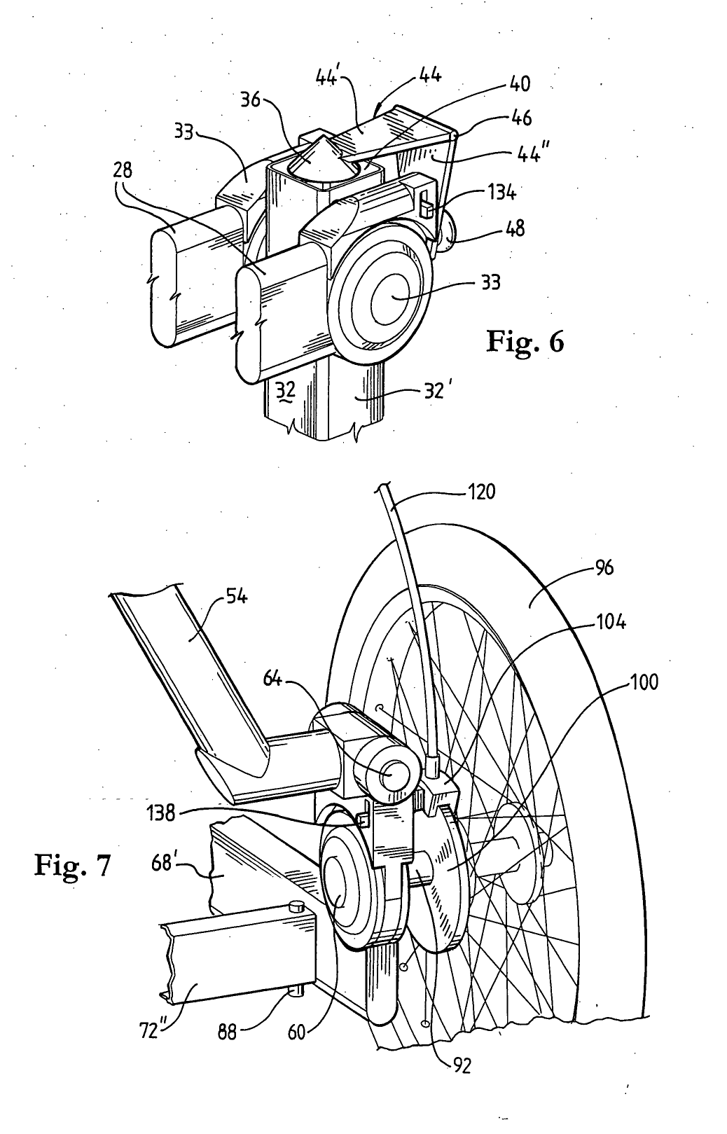

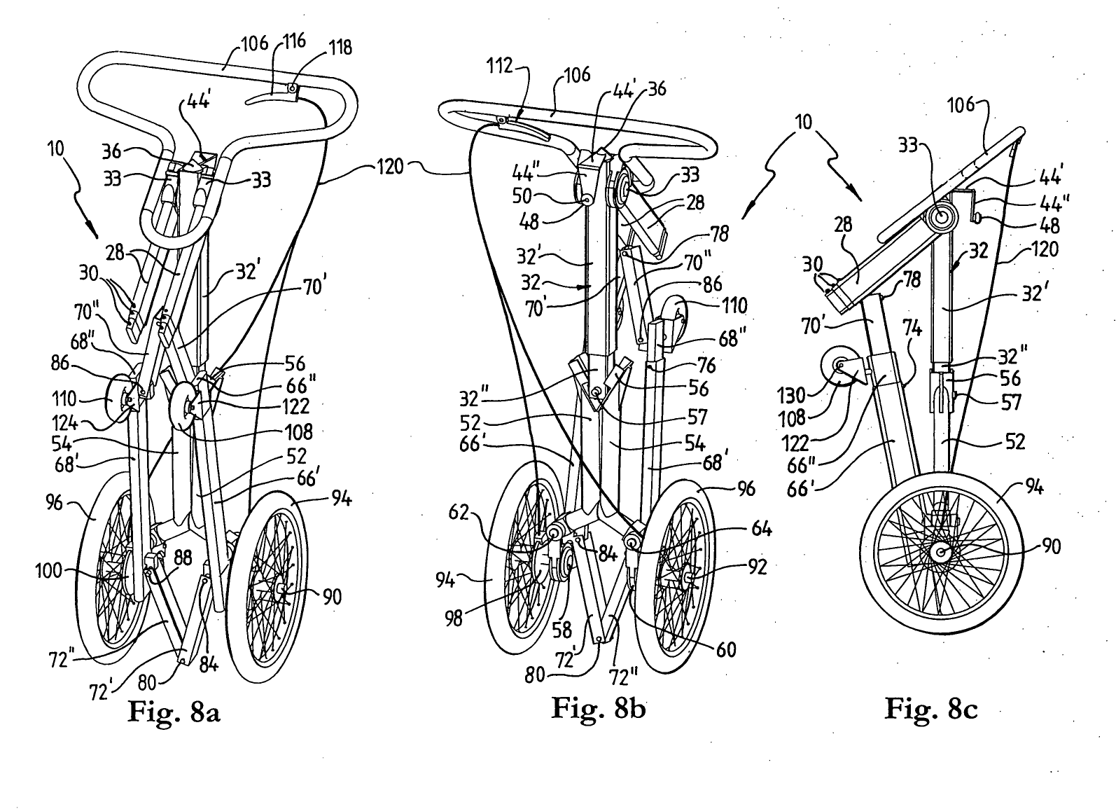

Referring now to FIGS. 2a to 6 in particular, it can be seen that a bag support member 28 is affixed substantially at right angles to either side of the upper most section of a stanchion 32 (see FIG. 6 for an enlarged view). Bag support members 28 are coupled to either side of stanchion 32 by way of a pair of locking pivot joints 33. Locking pivot joints 33 enable bag support members 28 of trolley 10 to be unlocked and moved to a collapsed position relative to stanchion 32 for storage and/or transportation as will be discussed later with reference to FIGS. 8a to 8c. In the accompanying representations, both bag support members 28 and both locking pivot joints 33 are represented by the same reference numeral since it should be appreciated that trolley 10 of the present invention could be embodied with a single bag support member 28 coupled to stanchion 32 by a single locking pivot joint 33. In such a case, trolley 10 could be designed to carry one, two or three bags 12, respectively.

Although shown in the drawings as including a single stanchion 32, it should be appreciated that trolley 10 could include more than one stanchion 32 if required and each stanchion 32 may have one or more bag support members 28 coupled thereto. Similarly, although not shown in the drawings, bag support members 28 of trolley 10 may be configured to be releasably attachable to locking pivot joints 33 such that bag support members 28, having bags 12 supported thereon, may be detachable from trolley 10 for storage and/or transportation purposes.

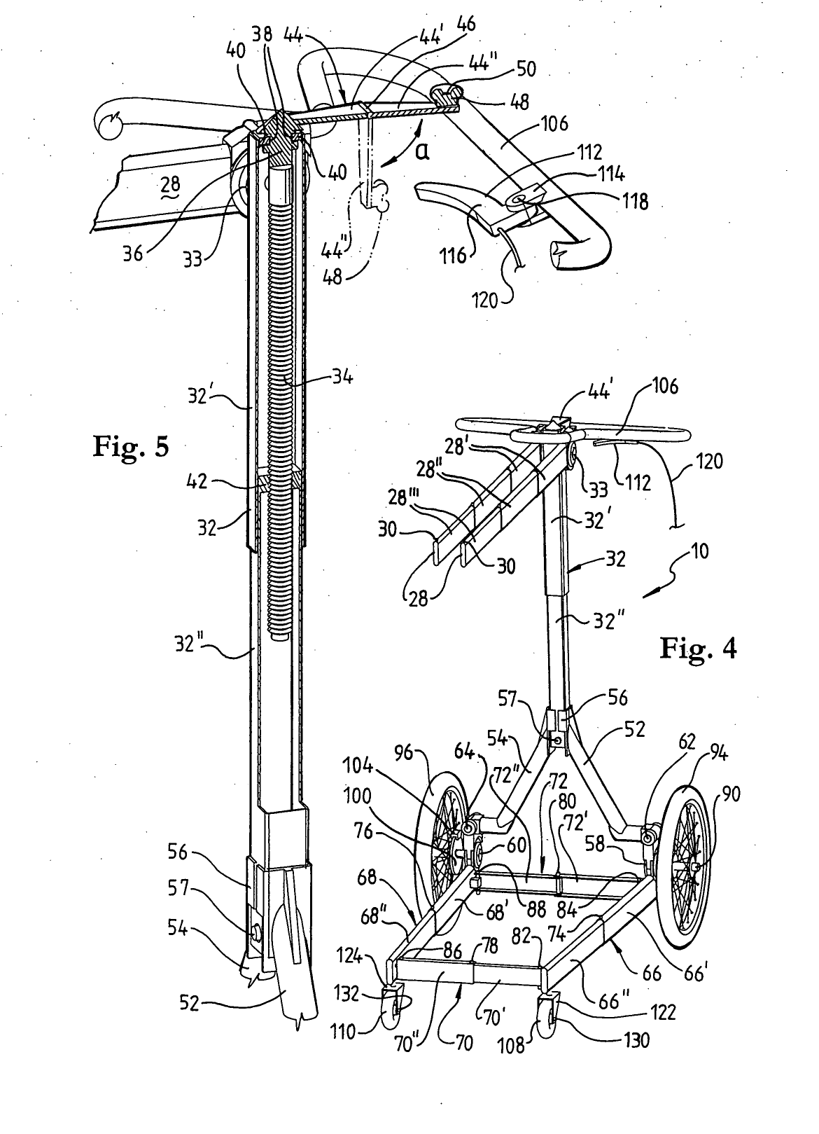

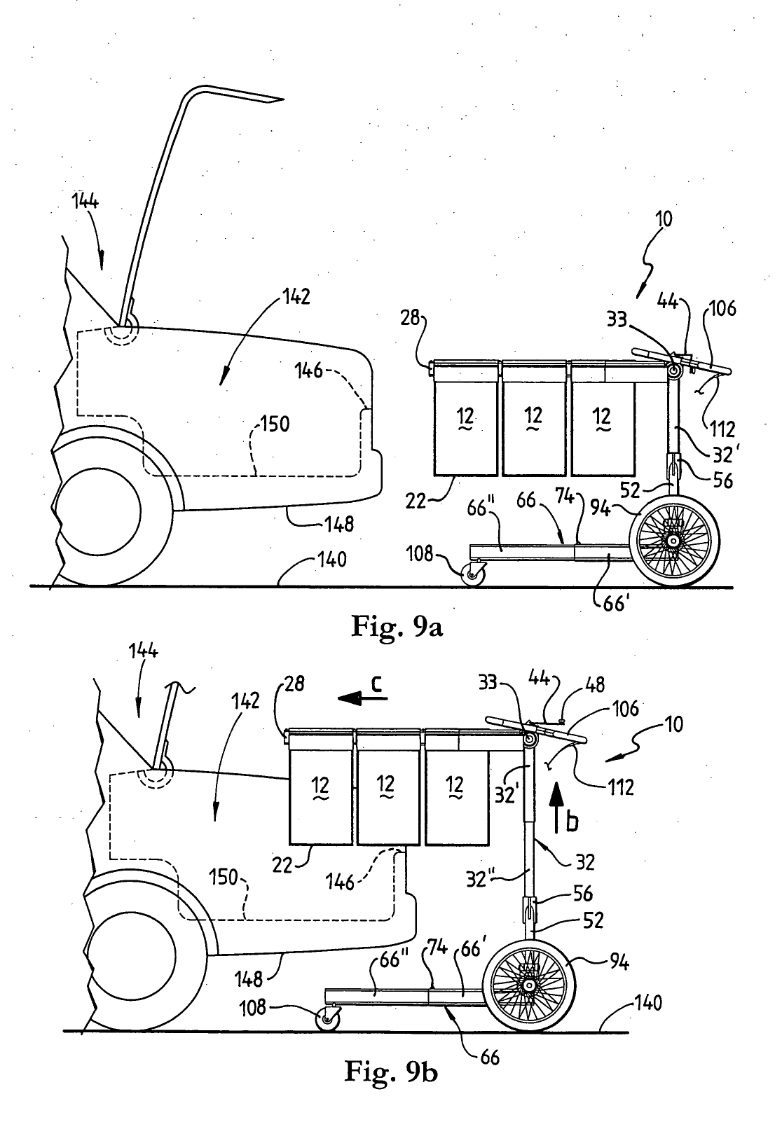

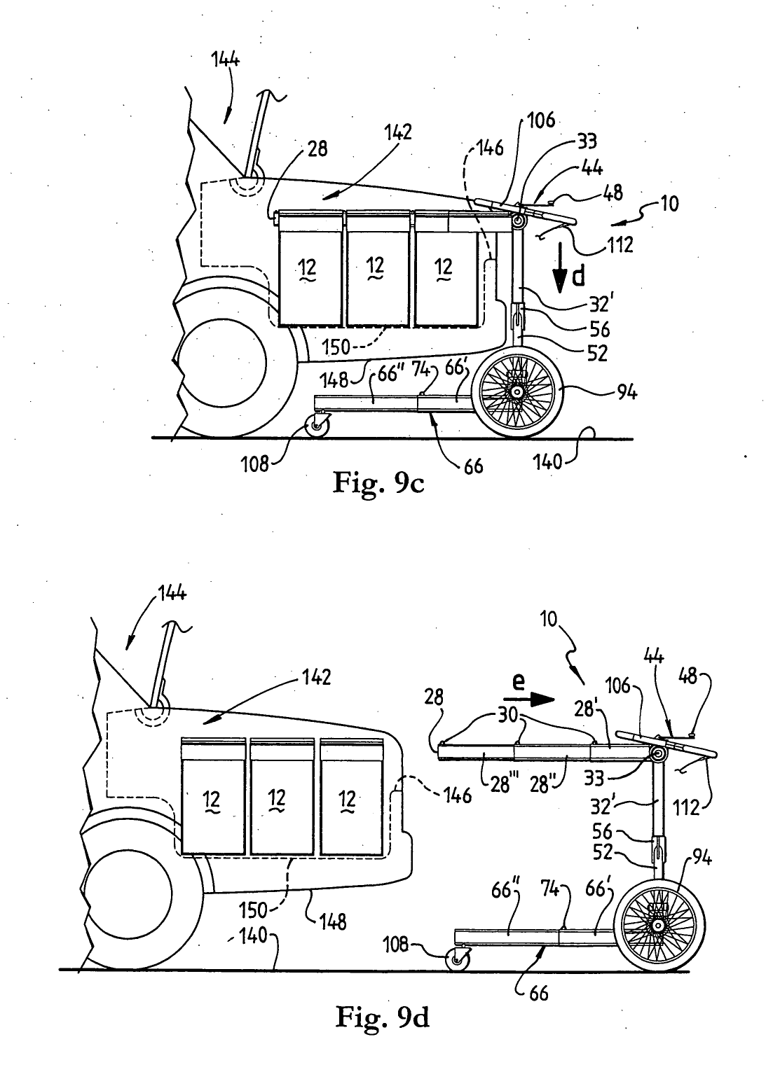

Stanchion 32 is composed of a first and second section 32′,32″ (see FIG. 4) which are disposed in a telescoping arrangement in order that first section 32′ is adapted to slidably receive therein second section 32″. Stanchion 32 is designed to be raised and lowered as desired to enable trolley 10 to assume varying heights. Telescoping stanchion 32 provides trolley 10 with a means of adapting to the varying height of users (not shown), and also enables bags 12 to be raised and lowered for loading and unloading purposes as will be discussed later with reference to FIGS. 9a to 9d.

To enable stanchion 32 of trolley 10 to be raised and lowered when required, stanchion 32 includes a centrally located threaded rod 34 which can be rotated to raise and lower first stanchion section 32′ relative to stationary second stanchion section 32″. In FIG. 5, it can be seen that the upper end or head 36 of threaded rod 34 is fixed and rotates relative to first stanchion section 32′. Head 36 of threaded rod 34 includes an axial groove 38 which cooperate with and receives therein in a fixed support portion 40 of first stanchion section 32′. Groove 38 and support portion 40 act as a bearing that provides the required fixed rotational movement of threaded rod 34. To enable first stanchion section 32′ to be raised and lowered relative to second stanchion section 32″, in cooperation with threaded rod 34, second stanchion section 32″ includes a captively held nut 42 disposed at an upper end thereof having an internally threaded hole matched to threaded rod 34. Captively held nut 42 provides threaded rod 34 with a means of raising and lowering first stanchion section 32′ relative to second stanchion section 32″ as threaded rod 34 is rotated. In use, when threaded rod 34 is rotated either in a clockwise or anti-clockwise direction by the use of a drive handle 44 disposed at the upper most point of stanchion 32, threaded rod 34 drives telescoping stanchion 32 to an extended (FIGS. 4 & 5) or retracted (FIGS. 2a & 2b) position which in turn raises and lowers bag support members 28, and hence bags 12, of trolley 10.

Referring to FIGS. 5 & 6, it can be seen that drive handle 44 is composed of a first and second drive handle section 44′,44″, which are hinged together by a centrally located pin 46. First drive handle section 44′ is fixed to head 36 of threaded rod 34 and rotates with head 36 as drive handle 44 is rotated in a clockwise or anti-clockwise direction. Second drive handle section 44″ is pivotally connected to first drive handle section 44′ by way of pin 46. Pin 46 enables second drive handle section 44″ to pivot between a rest position (see representation of second drive handle section 44″ in phantom lines in FIG. 5) and a working position (solid lines in FIG. 5) in the direction of arrow a. Drive handle 44 of trolley 10 is designed such that when stanchion 32 is to be raised or lowered, second drive handle section 44″ can be manipulated between its rest position and its working position, whereat drive handle 44 can be rotated in a clockwise or anti-clockwise direction as desired. The rest position of second drive handle section 44″ enables drive handle 44 to be tucked away when not in use.

To assist with the operation of the raising and lowering of stanchion 32, drive handle 44 is provided with a manipulation knob 48 which is disposed on the outer end of second drive handle section 44″, opposite hinge pin 46. Knob 48 is rotatably connected to second drive handle section 44″ by way of a pin 50. The arrangement of knob 48 relative to pin 50 enables knob 48 to be grasped by a user (not shown) as drive handle 44 is rotated to raise and lower stanchion 32. As drive handle 44 is rotated, knob 48 can be held stationary, as pin 50 enables knob 48 to rotate as required relative to second drive handle section 44″ of drive handle 44.

Although stanchion 32 is shown and described as having a mechanical screw-type lifting mechanism composed primarily of threaded rod 34, captively held nut 42 and drive handle 44, it should be understood that many other lifting mechanisms, as for example hydraulic or pneumatic lifting mechanisms, could also be used without departing from the spirit and scope of the present invention. As such the invention is not limited to the specific example provided.

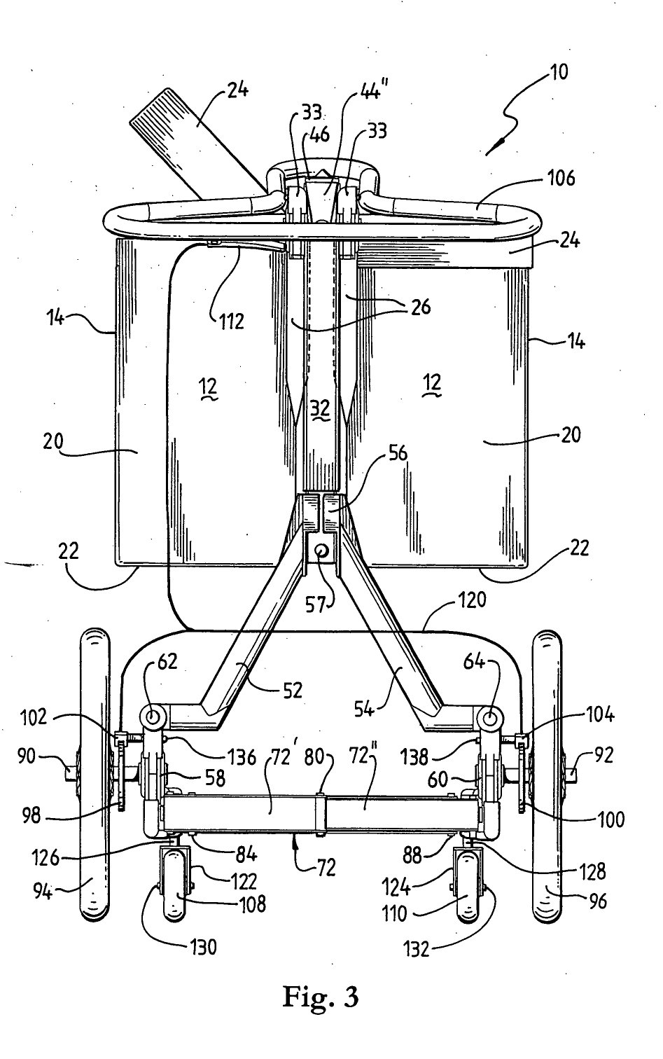

In FIGS. 2a to 3 in particular, it can be seen that stanchion 32 of trolley 10 is interconnected with a pair of declined frame members 52,54, which are coupled at their upper extremities to stanchion 32 by a coupling 56. Coupling 56 enables declined frame members 52,54 to be pivotally moved towards one another relative to a coupling pin 57 to a collapsed position of trolley 10 for storage and/or transportation as will be discussed later with reference to FIGS. 8a to 8c. Declined frame members 52,54 are each pivotally coupled at their lower extremities to a locking pivot joint 58,60 by way of a pin 62,64.

Locking pivot joints 58,60 are each coupled to an elongate base frame member 66,68, each of which extend forward of declined frame members 52,54. Base frame members 66,68 are disposed parallel to one another and are interconnected by way of a forward and rear cross-member 70,72. Base frame members 66,68 and forward and rear cross-members 70,72 form a generally rectangular base frame of trolley 10. Locking pivot joints 58,60, in association with pins 62,64, enable base frame members 66,68 to be unlocked and pivotally moved to a collapsed position relative to declined frame members 52,54 for storage and/or transportation as will be discussed later with reference to FIGS. 8a to 8c.

Base frame members 66,68 are each composed of a first section 66′,68′ and second section 66″,68″, respectively. First and second sections 66′,66″ of base frame member 66, and first and second sections 68′,68″ of base frame member 68, are each disposed in a telescoping arrangement in order that first sections 66′,68′ are adapted to slidably receive therein second sections 66″,68″. The telescoping arrangement of each of base frame members 66,68 enables the base of trolley 10 to be selectively and manually adjusted to vary the length of base frame members 66,68 to accommodate for more or less bags 12 loaded onto bag support members 28. When telescoping bag support members 28 are fully extended such that six bags 12 can be loaded thereon, telescoping base frame members 66,68 can be fully extended to support the weight applied to trolley 10 by groceries or other items (not shown) contained within bags 12. The telescoping arrangement of base frame members 66,68 also enables the base of trolley 10 to be collapsed for storage and/or transportation as will be discussed later with reference to FIGS. 8a to 8c.

To enable base frame members 66,68 to be locked into position in varying configurations, for example, the configurations of FIGS. 2a & 2b, base frame members 66,68 are each provided with a spring loaded locking pin 74,76. Locking pins 74,76 enable telescoping first and second sections 66′,68′,66″,68″ of base frame members 66,68 to be selectively and releasably locked into any of a number of desired extended or retracted positions.

Forward and rear cross-members 70,72 are each composed of a first section 70′,72′ and second section 70″,72″, respectively. First and second sections 70′,70″ of forward cross-member 70, and first and second sections 72′,72″ of rear cross-member 72, are each pivotally connected to one another by pins 78,80. First sections 70′,72′ of forward and rear cross-members 70,72 are pivotally connected to base frame member 66 by pins 82,84. Second sections 70″,72″ of forward and rear cross-members 70,72 are pivotally connected to base frame member 68 by pins 86,88. The pivotal connection of forward and rear cross-members 70,72 to base frame members 66,68 provided by pins 82,84,86,88, along with the pivotal connection of first and second sections 70′,72′,70″,72″ of forward and rear cross-members 70,72 provided by pins 78,80, enables forward and rear cross-members to pivot outwards at pins 78,80 as base frame members 66,68 are drawn towards one another to collapse the base of trolley 10 for storage and/or transportation purposes.

As can be best seen in FIG. 3, projecting from locking pivot joints 58,60 of trolley 10 are a pair of rear wheel axles 90,92 having a pair of rear wheels 94,96 affixed thereto. Each of rear wheels 94,96 rotate with their respective rear wheel axle 90,92. Rear wheel axles 90,92 freely rotate relative to locking pivot joints 58,60 in association with bearings (not shown) disposed within locking pivot joints 58,60.

To stop trolley 10 from moving or rolling away when trolley 10 is left unattended, trolley 10 is provided with a braking system. In FIGS. 3 & 7 in particular, it can be seen that a brake disc 98,100 is connected to each of rear wheel axles 90,92. Brake discs 98,100 are fixed to and rotate with rear wheel axles 90,92. Each brake disc 98,100 has an associated brake caliper 102,104 which is coupled to a respective locking pivot joint 58,60. Brake calipers 102,104 enable the rotation of rear wheels 94,96 to be stopped or restricted relative to brake discs 98,100.

To enable trolley 10 to be manoeuvred as desired, trolley 10 is also provided with a handle bar 106 and a pair of forward swivel-type wheels 108,110. Handle bar 106 is connected at the upper section of stanchion 32 to locking pivot joints 33 and has a brake lever 112 affixed thereto. Forward swivel wheels 108,110 are connected to the outer ends of base frame members 66,68, opposite locking pivot joints 58,60.

In FIG. 5, it can be seen that brake lever 112 is fixedly connected to handle bar 106 by a coupling 114. A lever portion 116 of brake lever 112 is pivotally connected to coupling 114 of brake lever 112 by a pin 118 which enables a brake cable 120 to be pulled when lever portion 116 is selectively and manually drawn towards handle bar 106 as required. Brake cable 120 is connected to brake calipers 102,104 and facilitates the compression and release of brake pads (not shown) housed within brake calipers 102,104 which selectively enable brake discs 98,100, and hence rear wheels 94,96, to rotate. It is preferred that the braking system of trolley 10 is configured to stop rear wheels 94,96 from rotating until lever portion 116 of brake lever 112 is drawn towards handle bar 106. It should be appreciated however, that the braking system of trolley 10 could be configured in many other ways and as such the invention is not limited to the specific example provided.

Although the braking system of trolley 10 is shown and described as being controlled by a brake lever 112 which is fixedly connected to handle bar 106 it should be understood that many other braking control mechanisms could also be used without departing from the spirit and scope of the present invention. For example, instead of having a brake lever 112, handle bar 106 of trolley 10 could be pivotally connected to the upper end of stanchion 32 in such a manner that downward or upward pivotal movement of handle bar 106 could selectively actuate brake calipers 102,104 in association with a brake cable 120. In this alternative embodiment (not shown), handle bar 106 of trolley 10 could be configured to provide a static or rest position wherein rear wheels 94,96 are free to rotate or are locked from movement until such a time that handle bar 106 is pivotally moved in an upward or downward manner. It should therefore be appreciated that the invention is not limited to the specific example provided.

In FIGS. 3 & 4 in particular, it can be seen that forward swivel wheels 108,110 are each connected to base frame members 66,68 by way of a saddle 122,124. Saddles 122,124 rotate relative to base frame members 66,68 by way of pins 126,128 which are fixedly connected to saddles 122,124. Swivel wheels 108,110 are disposed within saddles 122,124 and are rotatably connected thereto by way of pins 130,132.

Although shown in the accompanying representations as including two rear wheels 94,96 and two forward swivel wheels 108,110 it should be understood that more or less combinations of any suitable wheels could be used. For example, trolley 10 of the present invention could be embodied as having three wheels and hence only one forward swivel wheel or one rear wheel may be provided. The invention is therefore not limited to the specific example as shown and described with reference to the drawings.

As discussed earlier, trolley 10 of the present invention is configured to be collapsed for storage and/or transportation purposes if required. In FIGS. 8a to 8c there is shown various views of trolley 10 in a collapsed position.

Locking pivot joints 33, coupled to the upper section of stanchion 32, enable bag support members 28 along with handle bar 106 to assume the collapsed position shown in FIGS. 8a to 8c. In FIG. 6 it can be seen that locking pivot joints 33 each include a latching mechanism 134 which facilitates release of bag support members 28 from their locked position wherein bag support members 28 are disposed substantially at right angles relative to stanchion 32. When selectively manipulated, latching mechanisms 134 enable bag support members 28 to be rotated downwards and towards stanchion 32. As handle bar 106 is fixedly connected to locking pivot joints 33, handle bar 106 also moves with bag support members 28 to the collapsed position shown in FIGS. 8a to 8c. When trolley 10 is to be erected once again, bag support members 28 can be manipulated back to their locked position, wherein locking pivot joints 33 can be re-engaged to once again lock bag support members 28 into their erect position as is shown in FIGS. 1a to 5.

Coupling 56, disposed at the lower end of stanchion 32, enables declined frame members 52,54 to assume the collapsed position shown in FIGS. 8a to 8c. To assume the collapsed position shown in FIGS. 8a to 8c, declined frame members 52,54 are drawn towards one another which opens coupling 56 as declined frame members 52,54 pivot relative to pin 57. The action of drawing declined frame members 52,54 to a collapsed position also draws base frame members 66,68 towards one another, which in turn also causes forward and rear cross-members 70,72 to pivot outwards relative to pins 78,80 to allow base frame members 66,68 to assume the collapsed position of FIGS. 8a to 8c. When trolley 10 is to be erected once again, declined frame members 52,54 and/or base frame members 66,68 can be drawn outwards relative to one another which enables declined frame members 52,54, base frame members 66,68 and forward and rear cross-members 70,72 of trolley 10 to once again assume their erected position as is shown in FIGS. 1a to 5.

Locking pivot joints 58,60, coupled to base frame members 66,68 and declined frame members 52,54 enable base frame members 66,68 to assume the collapsed position shown in FIGS. 8a to 8c. In FIGS. 3 & 7 it can be seen that locking pivot joints 58,60 each include a latching mechanism 136,138 which facilitates release of base frame members 66,68 from their locked position wherein base frame members 66,68 are disposed substantially horizontal to a ground surface 140 (see FIGS. 9a to 9d). When selectively manipulated, latching mechanisms 136,138 enable base frame members 66,68 to be rotated upwards and towards declined frame members 52,54. Rear wheels 94,96, along with forward swivel wheels 108,110 move with base frame members 66,68 to the collapsed position shown in FIGS. 8a to 8c. When trolley 10 is to be erected once again, base frame members 66,68 can be manipulated back to their locked position, wherein locking pivot joints 58,60 can be re-engaged to once again lock base frame members 66,68 into their erect position as is shown in FIGS. 1a to 5.

In order to provide a better understanding of the operation of trolley 10 of the present invention, a preferred method of use of trolley 10 will now be described in detail with reference to FIGS. 9a to 9d. In these figures, trolley 10 is shown, in use, in various stages of operation, being used to load detachable bags 12 into the luggage compartment 142 of a motor vehicle 144.

In FIG. 9a trolley 10 is shown having bags 12 attached thereto and is stationed at the rear of vehicle 144 ready to load bags 12 into luggage compartment 142 of vehicle 144.

FIG. 9b shows the first and second stages of the operation of loading bags 12 into luggage compartment 142 of vehicle 144. The first stage of operation involves the use of drive handle 44 of stanchion 32, which is used to extend telescoping stanchion 32. When telescoping stanchion 32 is extended, first stanchion section 32′ is raised relative to second stanchion section 32″ in the direction of arrow b. The action of rotating drive handle 44 and extending telescoping stanchion 32 elevates bag support members 28, and hence bags 12, above ground surface 140 in the direction of arrow b. In use, drive handle 44 is manipulated to elevate bags 12 until bases 22 of bags 12 are sufficiently clear of the rear panel 146 of vehicle 144 in order to allow trolley 10 to be moved towards vehicle 144 in the direction of arrow c.

The second stage of operation involves the movement of trolley 10 towards vehicle 144 in the direction of arrow c. As stanchion 32 has been raised and bags 12 are clear of rear panel 146 of vehicle 144, trolley 10 can be moved towards vehicle 144 as required in order to position trolley 10 such that bags 12 are ready to be lowered into luggage compartment 142. In FIG. 9b it can be seen that as trolley 10 is moved towards vehicle 144 in the direction of arrow c the base of trolley 10 which includes base frame members 66,68, forward and rear cross-members 70,72 and swivel wheels 108,110, rolls along ground surface 140 and under the floor panel 148 of vehicle 144.

FIGS. 9c & 9d show the third and final stages of the operation of loading bags 12 into luggage compartment 142 of vehicle 144. The third stage of operation is shown in FIG. 9c. In this figure it can be seen that drive handle 44 of stanchion 32 has been used to lower bags 12 into luggage compartment 142 in the direction of arrow d. The action of rotating drive handle 44 of telescoping stanchion 32 retracts first stanchion section 32′ in the direction of arrow d relative to second stanchion section 32″ and in turn lowers bags 12 to the floor 150 of luggage compartment 142. Once bases 22 of bags 12 are safely stationed on floor 150 of luggage compartment 142, trolley 10 can be moved away from vehicle 144 in the direction of arrow e (FIG. 9d).

The final stage of operation involves the movement of trolley 10 away from vehicle 144 in the direction of arrow e. As can be seen in FIG. 9d, as trolley 10 is moved away from vehicle 144 in the direction of arrow e, bag support members 28 slide out of sleeves 26 of bags 12 which releases bags 12 from bag support members 28 leaving bags 12 positioned in luggage compartment 142. Bags 12 are now safely positioned in luggage compartment 142 of vehicle 144 ready for transportation. Trolley 10 can now be collapsed if required and also loaded into vehicle 144 for transportation.

Although not shown in the drawings, when bags 12 are to be removed from luggage compartment 142 of vehicle 144, trolley 10 could be used in the reverse manner to that shown in FIGS. 9a to 9d. Hence, bag support members 28 of trolley 10 could be slidably re-engaged with sleeves 26 of bags 12 by moving trolley 10 towards vehicle 144 in the reverse direction of arrow e (FIG. 9d). Once re-engaged with bags 12, telescoping stanchion 32 of trolley 10 could then be raised in the reverse direction of arrow d (FIG. 9c) using drive handle 44 until bags 12 are sufficiently clear of rear panel 146 of vehicle 144 in order to enable removal of bags 12 from luggage compartment 142. Finally, trolley 10 could then be moved away from vehicle 144 in the reverse direction of arrow c (FIG. 9b), and telescoping stanchion 32 lowered in the reverse direction of arrow b using drive handle 44, to safely position bags 12 closer to ground surface 140 for transportation using trolley 10.

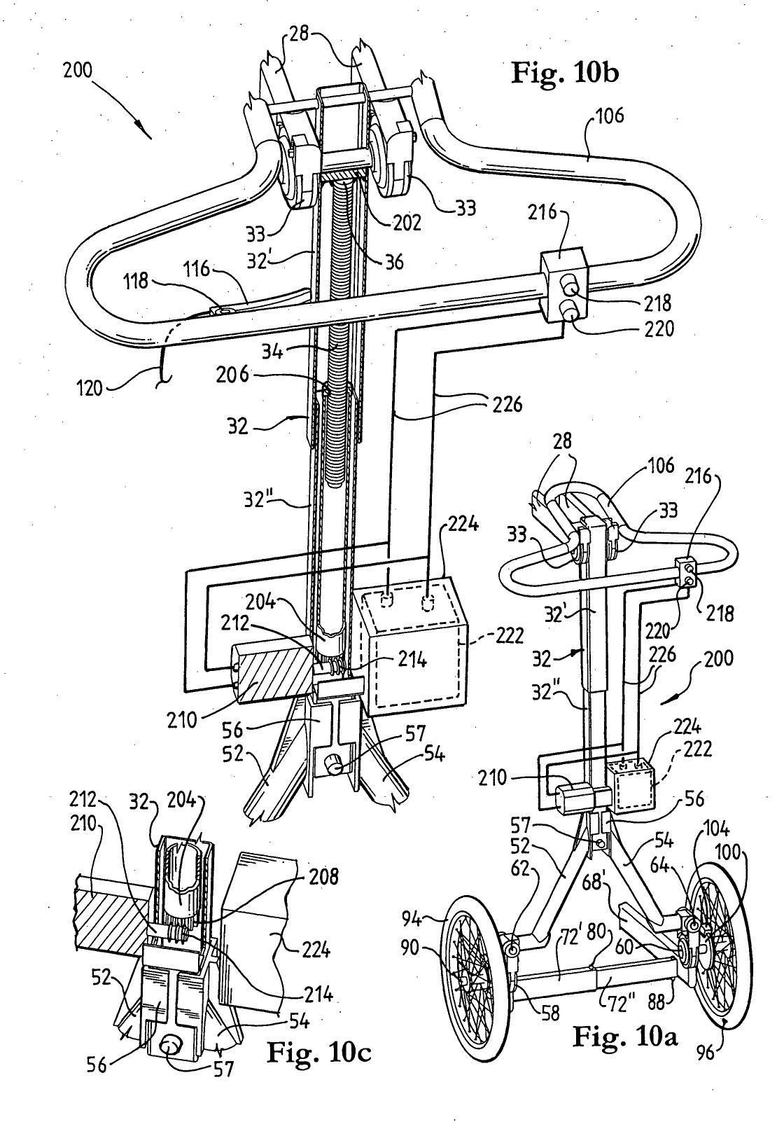

In FIGS. 10a to 10c there is shown a trolley 200, suitable for use as a shopping trolley, made in accordance with a second preferred embodiment of the present invention and which is also designed to carry a plurality of detachable shopping bags or baskets (not shown). It should be understood however, that trolley 200 may be used for many other applications and as such the invention is not limited to the specific example as shown. In FIGS. 10a to 10c like reference numerals correspond to like parts shown in FIGS. 1a to 9d.

Trolley 200 of FIGS. 10a to 10d varies to that of trolley 10 of FIGS. 1a to 9d with respect to the lifting mechanism used to raise and lower stanchion 32. Instead of having a threaded rod 34 which is manually controlled by a drive handle 44 as was shown and described with reference to trolley 10 of FIGS. 1a to 9d, trolley 200 of FIGS. 10a to 10c includes a motorised lifting system.

In FIGS. 10a to 10c, it can be seen that upper end or head 36 of threaded rod 34 is fixed to a thrusting block 202 which is fixed to or formed integral with first stanchion section 32′ and which is disposed at the upper end thereof relative handle 106. Thrust block 202 provides threaded rod 34 of stanchion 32 with a means of driving first stanchion section 32′ away from second stanchion section 32″.

To enable threaded rod 34 to raise first stanchion section 32′ relative to second stanchion section 32″ a centrally located cylindrical tube 204 having an internally threaded upper shoulder or captively held nut 206 and an external lower pinion gear 208 is provided. Threaded upper shoulder 206 receives threaded rod 34 and raises and lowers threaded rod 34 as cylindrical tube 204 is rotated in a clockwise and anti-clockwise direction. A motor 210 having a shaft 212 with a worm gear 214 formed thereon provides the required rotation of cylindrical tube 204. Worm gear 214 works with pinion 208 of cylindrical tube 204 to provide the required rotation of cylindrical tube 204.

In FIG. 10b it can be seen that a control device 216 is affixed to handle bar 106 of trolley 200. Control device 216 includes a first button 218 for activating motor 210 in one of a clockwise and anti-clockwise direction in order to extend telescoping stanchion 32, and a second button 220 for activating motor 210 in the other of a clockwise and anti-clockwise direction in order to retract telescoping stanchion 32.

Motor 210 is powered by a battery 222 housed within a battery housing 224 which is fixedly connected to the lower end of stanchion 32. To enable motor 210 to be powered by battery 222 and controlled by control device 216, trolley 200 includes a series of electrical wires 226 and any other electronic components (not shown) necessary to control motor 210.

In use, when a user (not shown) desires to raise of lower bag support members 28 or trolley 200, he or she can do so by simply pressing first or second buttons 218,220 of control device 216 as required.

The present invention therefore provides a useful trolley 10,200 which enables a plurality of detachable bags or containers 12 to be readily loaded and unloaded as required with the assistance of a suitable lifting mechanism disposed within or adjacent stanchion 32. The present invention also provides a trolley 10,200 which can be selectively adjusted to accommodate more or less bags or containers 12 as required depending on the intended use of the trolley. Finally, as the trolley 10,200 of the present invention encourages the use of specially designed reusable bags or containers 12, it is considered that use of trolley 10,200 will substantially reduce the effects that conventional plastic singlet-type bags have on the environment.

While this invention has been described in connection with specific embodiments thereof, it will be understood that it is capable of further modification(s). The present invention is intended to cover any variations, uses or adaptations of the invention following in general, the principles of the invention and including such departures from the present disclosure as come within known or customary practice within the art to which the invention pertains and as may be applied to the essential features hereinbefore set forth.

Finally, as the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. Various modifications and equivalent arrangements are intended to be included within the spirit and scope of the invention and appended claims. Therefore, the specific embodiments are to be understood to be illustrative of the many ways in which the principles of the present invention may be practiced. In the following claims, means-plus-function clauses are intended to cover structures as performing the defined function and not only structural equivalents, but also equivalent structures. For example, although a nail and a screw may not be structural equivalents in that a nail employs a cylindrical surface to secure wooden parts together, whereas a screw employs a helical surface to secure wooden parts together, in the environment of fastening wooden parts, a nail and a screw are equivalent structures.

1. A trolley comprising:
a frame having a base section and at least one stanchion coupled to said base section, said at least one stanchion including at least two telescoping sections coupled together in a slidable relationship;
a height adjustment means enabling the length of said at least one stanchion to be selectively adjusted by raising and lowering an upper telescoping section of said at least two telescoping sections relative to a lower telescoping section of said at least two telescoping sections;
wheel means rotatably coupled to said base section of said frame;
at least one handle member coupled to said upper telescoping section of said at least one stanchion for selectively manipulating said trolley; and
at least one support member coupled to said at least one stanchion at or near said upper telescoping section of said at least one stanchion, wherein said at least one support member extends substantially laterally from said at least one stanchion in a load supporting position and said at least one support member is adapted to receive and support at least one load carrying bag or container.

2. The trolley as claimed in claim 1, wherein said at least one support member of said trolley includes at least two telescoping sections coupled-together in a slidable relationship which enable the length of said at least one support member to be selectively adjusted in order to vary the load carrying capacity thereof.

3. The trolley as claimed in claim 2, wherein said at least one support member of said trolley is adapted to receive and support a plurality of load carrying bags or containers, and wherein said at least two telescoping sections of said at least one support member enable the length of said at least one support member to be selectively adjusted in order to receive and support more or less bags or containers as required.

4. The trolley as claimed in claim 1, wherein said at least one support member of said trolley includes three telescoping sections coupled together in a slidable relationship.

5. The trolley as claimed in claim 4, wherein each of said three telescoping sections of said at least one support member of said trolley are adapted to receive and support a single bag or container.

6. The trolley as claimed in claim 5, wherein said trolley includes two support members and said two support members can be selectively adjusted to enable said trolley to receive and support up to six bags or containers.

7. The trolley as claimed in claim 1, wherein said at least one support member and said base section are disposed in a parallel relationship.

8. The trolley as claimed in claim 7, wherein the length of said base section of said frame is selectively adjustable in order to counteract the load received and supported on said at least one support member of said trolley.

9. The trolley as claimed in claim 1, wherein said trolley includes one stanchion having two telescoping sections, one telescoping section being the upper telescoping section and the other telescoping section being the lower telescoping section, and wherein one of said upper and lower telescoping sections slidably receives therein the other of said upper and lower telescoping sections.

10. The trolley as claimed in claim 9, wherein said height adjustment means of said stanchion includes a threaded rod disposed internally of or adjacent to said upper and lower telescoping sections, wherein said threaded rod is rotatably fixed at or near one end thereof to one of said upper or lower telescoping sections, and wherein said threaded rod is threadably received within a captively held nut fixedly connected to the other or said upper and lower telescoping sections.

11. The trolley as claimed in claim 10, wherein said trolley includes a height adjustment control lever disposed above said stanchion which is coupled to and rotates with said threaded rod, said control lever being selectively operable in a clockwise or anti-clockwise direction to impart a rotational movement on said threaded rod, and wherein said rotational movement of said threaded rod causes said threaded rod to move up or down relative to said captively held nut which in turn selectively adjusts the height of said stanchion.

12. The trolley as claimed in claim 9, wherein said height adjustment means of said stanchion includes a threaded rod disposed internally of or adjacent to said upper and lower telescoping sections, wherein said threaded rod is rotatably fixed at or near one end thereof to one of said upper or lower telescoping sections, and wherein said threaded rod is threadably received within a captively held nut disposed at or near one end of a cylindrical tube disposed substantially within or adjacent to the other or said upper and lower telescoping sections, and wherein said cylindrical tube includes a pinion gear disposed at or near the end of said cylindrical tube.

13. The trolley as claimed in claim 12, wherein said trolley further includes a motor having a shaft with a worm gear formed thereon, said worm gear being disposed adjacent said pinion gear of said cylindrical tube, said trolley including control means to selectively control said motor in order to impart a clockwise or anti-clockwise rotational movement on said shaft of said motor, wherein when said shaft of said motor is rotated, said worm gear imparts a rotational movement on said cylindrical tube by way of said pinion gear, and wherein said rotational movement of said cylindrical tube causes said threaded rod to move up or down relative to said captively held nut which in turn selectively adjusts the height of said stanchion.

14. The trolley as claimed in claim 9, wherein said height adjustment means of said stanchion is a hydraulic or pneumatic lifting mechanism disposed internally of or adjacent to said upper and lower telescoping sections.

15. The trolley as claimed in claim 1, wherein said base section of said frame and said at least one stanchion are coupled together by at least one pivot joint which enables said base section to be selectively folded towards and relative to said at least one stanchion in order to facilitate a collapsed position of said trolley for storage and/or transportation purposes.

16. The trolley as claimed in claim 15, wherein said at least one support member and said at least one stanchion are coupled together by at least one pivot joint which enables said at least one support member to be selectively folded towards and relative to said at least one stanchion in order to facilitate the collapsed position of said trolley for storage and/or transportation purposes.

17. The trolley as claimed in claim 15, wherein said at least one pivot joint includes a selectively operable latching mechanism which selectively enables said base section to be locked into an erect position relative to said at least one stanchion.

18. The trolley as claimed in claim 16, wherein said at least one pivot joint includes a selectively operable latching mechanism which selectively enables said at least one support member to be locked into an erect position relative to said at least one stanchion.

19. The trolley as claimed in claim 1, wherein said wheel means of said trolley includes two rear wheels rotatably coupled to said base section of said frame at or near a rear end thereof, and two forward swivel or castor wheels rotatably coupled to said base section of said frame at or near a forward end thereof.

20. The trolley as claimed in claim 19, further including a braking means coupled to at least one of said rear wheels, wherein said braking means is controllable via at least one brake lever disposed on or near said at least one handle member of said trolley or is controllable via pivotal movement of said at least one handle member of said trolley.
